(19) United States
(12) Patent Application Publication
(10) Pub. No.: US 2026/0092869 A1
(43) Pub. Date: Apr. 2, 2026

(54) ELECTRIC FIELD ENHANCEMENT DEVICE AND RAMAN SPECTROSCOPIC APPARATUS

(71) Applicant: SEIKO EPSON CORPORATION, Tokyo (JP)

(72) Inventors: Yoshitaka ITO, MATSUMOTO-SHI (JP); Fumika YAMADA, SHIOJIRI-SHI (JP); Kaho TAKEUCHI, MATSUMOTO-SHI (JP)

(73) Assignee: SEIKO EPSON CORPORATION, Tokyo (JP)

(21) Appl. No.: 19/318,382

(22) Filed: Sep. 4, 2025

(30) Foreign Application Priority Data
Sep. 6, 2024 (JP) 2024-153788

(51) Int. Cl. G01N 21/65; G01N 21/552

(52) U.S. Cl. CPC G01N 21/658; G01N 21/554

(57) ABSTRACT

An electric field enhancement device includes a substrate, a plurality of microstructures provided to the substrate and having electrical conductivity, and a silicon oxide layer configured to cover the plurality of microstructures and the substrate, wherein an enhanced electric field generated by the plurality of microstructures is maximized at a position located at an opposite side of the microstructures to the substrate and separated from the plurality of microstructures in a normal direction to the substrate.

The present application is based on, and claims priority from JP Application Serial Number 2024-153788, filed Sep. 6, 2024, the disclosure of which is hereby incorporated by reference herein in its entirety.

### BACKGROUND

### 1. Technical Field

The present disclosure relates to an electric field enhancement device and a Raman spectroscopic apparatus.

### 2. Related Art

A Raman spectroscopic apparatus using localized surface plasmon resonance (LSPR) is known as one of spectroscopic techniques for detecting low-concentration sample molecules. In such a Raman spectroscopic apparatus, an enhanced electric field is formed by an electric field enhancement device having a nanometer-scale microstructure to generate surface enhanced Raman scattering (SERS) in which Raman scattered light is enhanced.

For example, JP-A-2013-096939 discloses an optical device including a substrate, a metal microstructure which is configured with a plurality of metal particles and is formed on a surface of the substrate, and an organic molecular film formed on the metal microstructure.

JP-A-2013-096939 is an example of the related art.

In such an optical device as described above, a further improvement in detection sensitivity is required.

### SUMMARY

An electric field enhancement device according to an application example of the present disclosure includes:
a substrate;
a plurality of microstructures provided to the substrate and having electrical conductivity; and
a silicon oxide layer configured to cover the plurality of microstructures and the substrate, wherein
an enhanced electric field generated by the plurality of microstructures is maximized at a position located at an opposite side of the microstructures to the substrate and separated from the plurality of microstructures in a normal direction to the substrate.

A Raman spectroscopic apparatus according to an application example of the present disclosure includes:
the electric field enhancement device according to the application example of the present disclosure;
a light source configured to irradiate the electric field enhancement device with light; and
a detector configured to detect light from the electric field enhancement device.

### BRIEF DESCRIPTION OF THE DRAWINGS

FIG. 1 is a cross-sectional view schematically showing an electric field enhancement device according to an embodiment.

FIG. 2 is a plan view schematically showing the electric field enhancement device according to the embodiment.

FIG. 3 is a plan view schematically showing the electric field enhancement device according to the embodiment.

FIG. 4 is a plan view schematically showing the electric field enhancement device according to the embodiment.

FIG. 5 is a plan view schematically showing the electric field enhancement device according to the embodiment.

FIG. 6 is a plan view schematically showing the electric field enhancement device according to the embodiment.

FIG. 7 is a conceptual diagram illustrating the plasmon resonance in the electric field enhancement device.

FIG. 8 is a conceptual diagram illustrating the plasmon resonance in the electric field enhancement device.

FIG. 9 is a diagram illustrating an enhanced electric field generated by the microstructure of the electric field enhancement device.

FIG. 10 is a cross-sectional view schematically showing an electric field enhancement device according to a first modified example of the embodiment.

FIG. 11 is a cross-sectional view schematically showing an electric field enhancement device according to a second modified example of the embodiment.

FIG. 12 is a diagram schematically showing a Raman spectroscopic apparatus according to the embodiment.

FIG. 13 is a diagram illustrating the principle of Raman scattering spectroscopy.

FIG. 14 is a schematic diagram showing an example of a Raman spectrum acquired by the Raman scattering spectroscopy.

FIG. 15 is an X-Z cross-sectional view schematically showing a repeating unit of a model used in a simulation.

FIG. 16 is an X-Y cross-sectional view schematically showing the model used in the simulation.

FIG. 17 is a table showing a comparison of principal parameters in Practical Examples 1 and 2 and Comparative Example 1.

FIG. 18 is a diagram showing a simulation result of Practical Example 1.

FIG. 19 is a diagram showing a simulation result of Practical Example 2.

FIG. 20 is a diagram showing a simulation result of Comparative Example 1.

### DESCRIPTION OF EMBODIMENTS

An electric field enhancement device and a Raman spectroscopic apparatus of the present disclosure will hereinafter be described in detail based on an embodiment shown in the accompanying drawings.

### 1. Electric Field Enhancement Device

First, an electric field enhancement device according to the embodiment will be described.

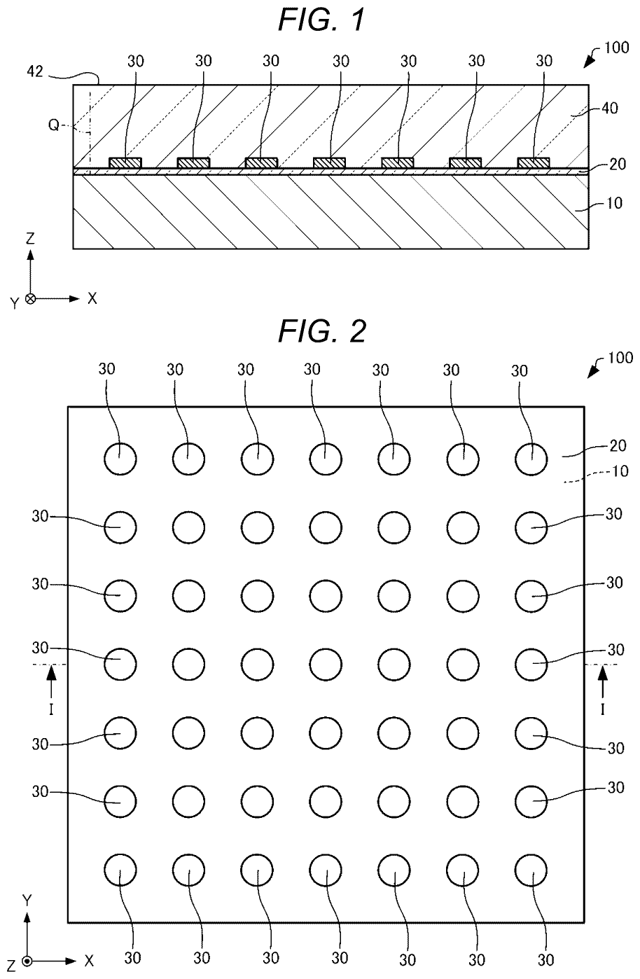

FIG. 1 is a cross-sectional view schematically showing the electric field enhancement device 100 according to the present embodiment. FIGS. 2 to 6 are each a plan view schematically showing the electric field enhancement device 100 according to the embodiment. Note that FIG. 1 is a cross-sectional view along the line I-I in FIG. 2. Further, in each of the drawings of the present application, an X axis, a Y axis, and a Z axis are set as three axes orthogonal to each another, and are respectively indicated by arrows. Further, a tip side of the arrow of each axis is referred to as a “plus side”, and a base end side thereof is referred to as a “minus side”. Further, the Z axis plus side is also referred to as “upside”, and the Z axis minus side is also referred to as “downside”.

### 1.1. Configuration

The electric field enhancement device 100 shown in FIGS. 1 and 2 includes a substrate 10, a dielectric layer 20, microstructures 30, and a silicon oxide layer 40. Note that in FIGS. 2 to 6, the silicon oxide layer 40 is not shown.

The substrate 10 supports a plurality of microstructures 30 via the dielectric layer 20. When light from a light source used for Raman scattering is incident from the substrate 10 side in FIG. 1, the incident light is transmitted through the substrate 10 and the dielectric layer 20 and reaches the microstructures 30. When the light is incident from the silicon oxide layer 40 side in FIG. 1, the incident light is transmitted through the silicon oxide layer 40 and reaches the microstructures 30. Note that in this case, it may be arranged that the incident light is reflected by the substrate 10 toward the silicon oxide layer 40.

When the incident light reaches the plurality of microstructures 30, an enhanced electric field is generated. The enhanced electric field is maximized at a position at an opposite side of the microstructure 30 to the substrate 10 in a normal direction to the substrate 10 and separated from the plurality of microstructures 30.

According to such a configuration, the detection signal caused by the target substance disposed on the silicon oxide layer 40 can be enhanced. Therefore, the electric field enhancement device 100 in which an improvement in the detection sensitivity of the target substance is achieved can be obtained.

Examples of the substrate 10 include a glass substrate and a silicon substrate. Examples of the material of the glass substrate include SiO₂ (quartz glass). Examples of the material of the silicon substrate include single crystal silicon, polycrystalline silicon, and amorphous silicon.

In FIG. 1, a perpendicular line to the upper surface of the substrate 10 is represented by Q. In FIG. 1, a perpendicular line Q is set to be parallel to the Z axis.

The dielectric layer 20 shown in FIG. 1 is disposed between the substrate 10 and the microstructures 30. The thickness of the dielectric layer 20 is not particularly limited, but is preferably no less than 1 nm and no more than 2000 nm, and more preferably no less than 10 nm and no more than 1000 nm. Note that the dielectric layer 20 may be omitted.

The thickness of the dielectric layer 20 is measured from an observation image obtained by observing a cross-section of the dielectric layer 20 with an electron microscope. In the observation image, the length in the Z-axis direction of the dielectric layer 20 is measured at 10 or more points extracted randomly, and an average value thereof is defined as the “thickness”.

The dielectric layer 20 is transparent with respect to the light from the light source. Examples of the material of the dielectric layer 20 include Al₂O₃, TiO₂, MgO, LiNbO₃, HfO₂, Ta₂O₅, SiON, Si₃N₄, SiOx (0<x<3), PMMA (acrylic resin), PVA (polyvinyl alcohol), and polysilazane. The dielectric layer 20 may be formed of a plurality of layers. In this case, the materials of the plurality of layers may be the same as each other, or may be different from each other.

The microstructures 30 shown in FIG. 1 are disposed between the dielectric layer 20 and the silicon oxide layer 40. The microstructure 30 has, for example, a cylindrical shape. The diameter of the microstructure 30 is not particularly limited, but is preferably no less than 1 nm and no more than 1000 nm, more preferably no less than 5 nm and no more than 500 nm, and still more preferably no less than 10 nm and no more than 400 nm.

Note that when the planar shape (the shape when viewed on the Z axis) of the microstructure 30 is a circle, the “diameter of the microstructure 30″ is a diameter of the circle, and when the planar shape of the microstructure 30 is not a circle, the ”diameter of the microstructure 30″ is a diameter of a minimum inclusion circle. As an example of the latter, when the planar shape of the microstructure 30 is a polygon, a minimum circle including the polygon inside is the “minimum inclusion circle”. Further, when the planar shape of the microstructure 30 is an ellipse, a minimum circle including the ellipse inside is the “minimum inclusion circle”.

The thickness of the microstructures 30 is not particularly limited, but is preferably no less than 1 nm and no more than 500 nm, more preferably no less than 5 nm and no more than 300 nm, and still more preferably no less than 30 nm and no more than 200 nm. Accordingly, the enhanced electric field can further be strengthened.

The plurality of microstructures 30 is disposed. The plurality of microstructures 30 is separated from each other. The silicon oxide layer 40 is disposed between the microstructures 30 adjacent to each other. A pitch of the microstructures 30 adjacent to each other is not particularly limited, but is preferably no less than 20 nm and no more than 1000 nm, and more preferably no less than 100 nm and no more than 900 nm.

Further, the plurality of microstructures 30 is periodically disposed in a predetermined direction when viewed from the Z-axis direction. In the example shown in FIG. 2, the plurality of microstructures 30 is arranged in a square lattice shape.

According to such a configuration, in the electric field enhancement device 100, it is possible to reduce a variation in the intensity of the enhanced electric field in an in-plane direction of the substrate 10. When the plurality of microstructures is randomly arranged, only the microstructures which are arranged in a pitch corresponding to the wavelength of the light from the light source and which have a diameter corresponding to that wavelength induce the LSPR. Therefore, there is a possibility that the intensity of the enhanced electric field varies in the in-plane direction. In contrast, since the microstructures 30 are periodically disposed, it is easy to induce surface lattice resonance (SLR) described later.

Note that the “pitch of the microstructures 30” is a distance between the centers of the microstructures 30 adjacent to each other in a predetermined direction. When the planar shape of the microstructure 30 is a circle, the “center of the microstructure 30″ is the center of the circle, and when the planar shape of the microstructure 30 is not a circle, the ”center of the microstructure 30″ is the center of the minimum inclusion circle.

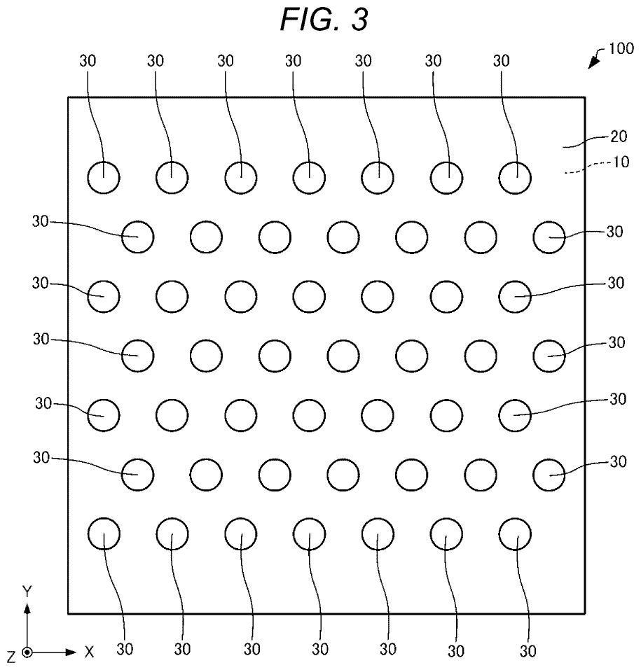

Further, when viewed from the Z-axis direction, the plurality of microstructures 30 may be disposed in a triangular lattice shape as illustrated in FIG. 3. Further, although not illustrated, the periodicity of the plurality of microstructures 30 may expand or contract at a certain ratio, and the plurality of microstructures 30 may include a fractal structure.

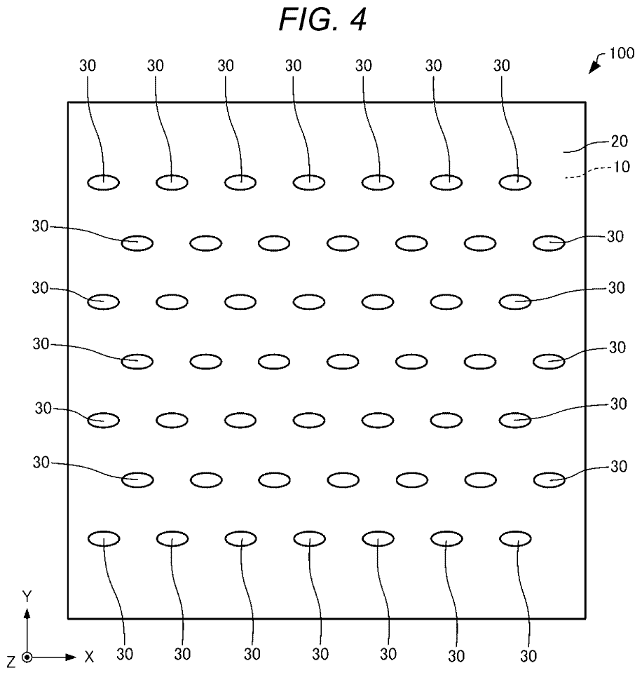

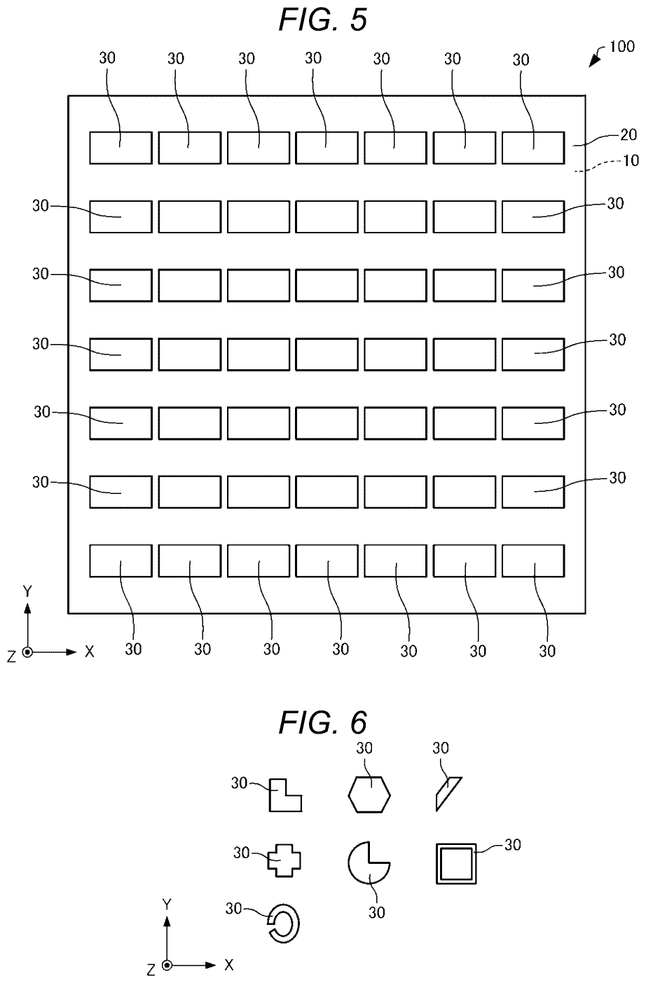

The planar shape of the microstructure 30 is not limited to a circular shape. For example, the planar shape of the microstructure 30 may be an elliptical shape as illustrated in FIG. 4, may be a rectangular shape as illustrated in FIG. 5, or may be a shape such as a particle shape, a polygonal shape, an annular shape, or a linear shape as illustrated in FIG. 6. Further, the plurality of microstructures 30 may be a combination of those different in shape from each other. Accordingly, it is possible to control the intensity and distribution of the enhanced electric field generated by the plurality of microstructures 30 in the in-plane direction orthogonal to the perpendicular line Q.

In addition, the cross-sectional shape of the microstructures 30 is not particularly limited, and may be a trapezoid, a semicircle, a circle, a reverse tapered shape, a tip spherical shape, or the like. Further, the shapes of the microstructures 30 may each be a truncated quadrangular pyramid or a cone.

Further, although not illustrated, a plurality of recesses may be provided to the upper surface of the dielectric layer 20, and the microstructures 30 may be disposed in the recesses.

The microstructures 30 have electrical conductivity. Examples of the material of the microstructures 30 include simple substances or alloys of metals such as Al, Au, Ag, Cu, Pt, Pd, and Ni. Since such a metal has particularly good electrical conductivity, the enhanced electric field can be further strengthened. Further, the microstructures 30 may be metal particles. Note that the material of the microstructures 30 is not particularly limited as long as the material has a plasma frequency with respect to the light from the light source, and may be a transparent electrode material such as indium tin oxide (ITO), a carbon-based material such as carbon nanotubes, or the like.

The silicon oxide layer 40 is disposed on the microstructures 30 and the dielectric layer 20. That is, the silicon oxide layer 40 is disposed to cover the plurality of microstructures 30 and the substrate 10. The thickness of the silicon oxide layer 40 is not particularly limited, but is preferably no less than 10 nm and no more than 2000 nm, and more preferably no less than 20 nm and no more than 1000 nm.

The thickness of the silicon oxide layer 40 is measured from an observation image obtained by observing a cross-section of the silicon oxide layer 40 with an electron microscope. In the observation image, the length in the Z-axis direction of the silicon oxide layer 40 is measured at 10 or more points extracted randomly, and an average value thereof is defined as the “thickness”.

The silicon oxide layer 40 is transparent with respect to the light from the light source. The material of the silicon oxide layer 40 is silicon oxide. In the present specification, the silicon oxide is defined as a composition represented by SiOx (0<x<3), but is preferably represented by SiOx (1<x≤2).

The refractive index of the silicon oxide layer 40 may be different from, or may be the same as, the refractive index of the dielectric layer 20. When the refractive index of the silicon oxide layer 40 is the same as the refractive index of the dielectric layer 20, a Rayleigh anomaly described later is apt to be generated. Further, when the dielectric layer 20 is omitted, the refractive index of the silicon oxide layer 40 may be higher, or may be lower, than the refractive index of the substrate 10, but the difference therebetween is preferably set to no more than 0.20. When the refractive index difference is within this range, the influence of the refractive index difference is suppressed, and the Rayleigh anomaly described later is likely to occur regardless of the incident direction of the light. As a result, the SLR described later is apt to be induced. Note that when the refractive index difference is out of the range described above, when, for example, the light is incident from the substrate 10 side, Fresnel reflection is likely to occur on an interface between the substrate 10 and the silicon oxide layer 40. As a result, there is a possibility that the optical energy making a contribution to the generation of the plasmon resonance described later decreases to decrease the enhanced electric field.

The silicon oxide layer 40 has an upper surface 42. The upper surface 42 is, for example, an interface between the silicon oxide layer 40 and an air layer. Further, the upper surface 42 is a surface on which the target substance to be detected is disposed. The upper surface 42 shown in FIG. 1 is preferably a flat surface. In this case, the target substance can be stably arranged.

The surface roughness of the upper surface 42 is not particularly limited, but the maximum height Rz is preferably set no more than 20 nm, and more preferably set no more than 15 nm. When the surface roughness is within the range described above, the smoothness of the upper surface 42 can sufficiently be increased. Therefore, it becomes easy to achieve homogenization of the enhanced electric field formed above the upper surface 42. As a result, it becomes easy to improve the reproducibility of the detection. Further, even when target substances in various sizes are mixed, the detection signals caused by the target substances can be uniformly enhanced.

The maximum height Rz is obtained in such a manner as described below. First, the upper surface 42 is observed with an atomic force microscope (AFM) to obtain an observation image. Then, a surface shape of the observation image is clipped along a line passing above the microstructure 30. Then, the maximum height Rz is obtained from a line profile obtained.

### 1.2. Enhanced Electric Field

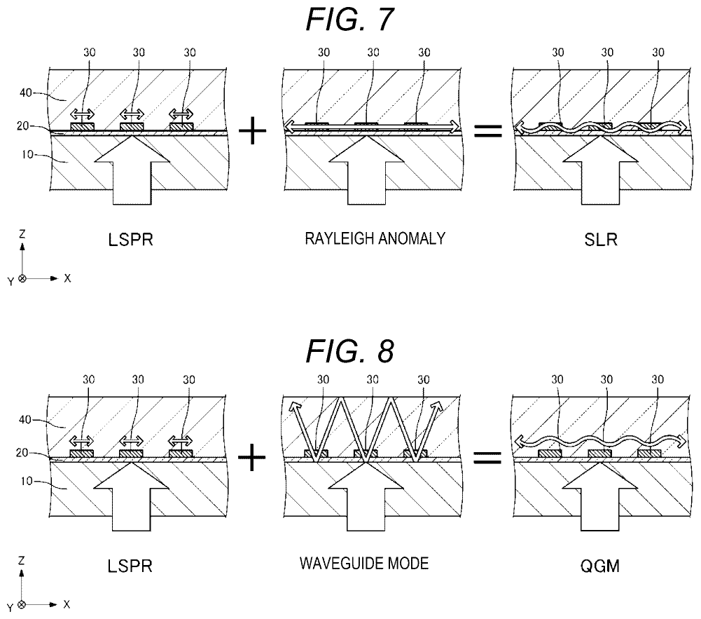

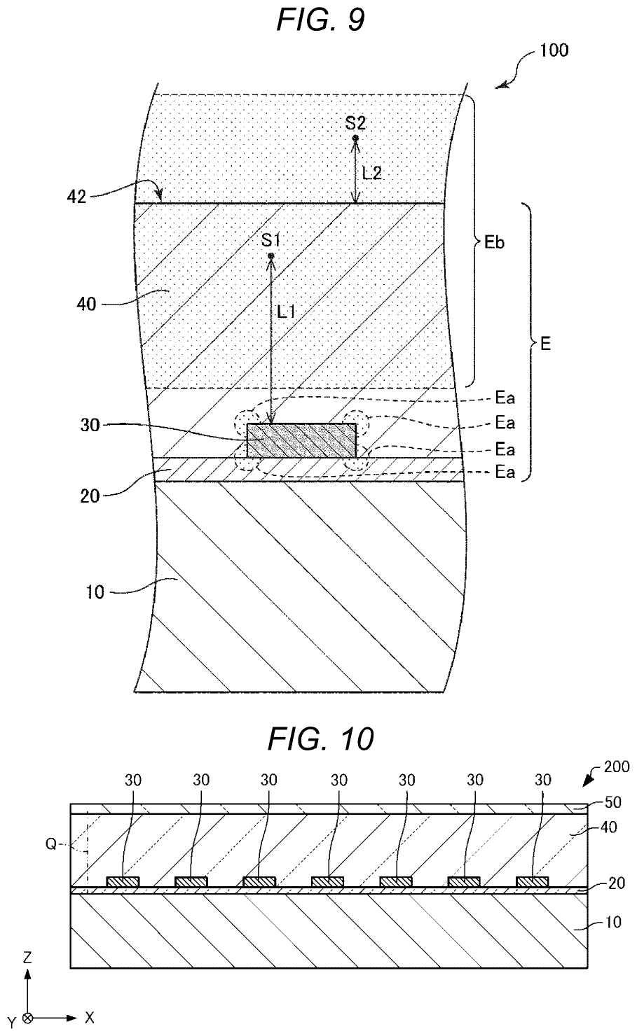

FIGS. 7 and 8 are conceptual diagrams illustrating the plasmon resonance in the electric field enhancement device 100. FIG. 9 is a diagram illustrating an enhanced electric field E generated by the microstructure 30 of the electric field enhancement device 100.

In the example illustrated in FIGS. 7 and 8, the light incident from the substrate 10 side reaches the plurality of microstructures 30. The light that has reached the microstructure 30 causes the plurality of microstructures 30 to generate the plasmon resonance. The wavelength of the light is, for example, no less than 350 nm and no more than 850 nm. When the wavelength of light is within the range described above, the plasmon resonance is easily generated in the microstructure 30.

As shown in FIG. 7, when the light reaches the microstructure 30, the LSPR described above is induced. In addition, 90°-diffraction by the plurality of microstructures 30, that is, Rayleigh anomaly occurs. When the Rayleigh anomaly and the LSPR are combined, the surface lattice resonance (SLR) is induced.

Further, as shown in FIG. 8, the incident light is guided through the silicon oxide layer 40. By combining the waveguide mode in the silicon oxide layer 40 and the LSPR, a quasi-guided mode (QGM) is induced.

Then, the SLR and the resonance state such as QGM are combined and cooperate, and cooperative plasmon polaritons are induced in the plurality of microstructures 30. As illustrated in FIG. 9, the enhanced electric field E generated by the plurality of microstructures 30 due to the combination of the SLR and the resonance state such as the QGM includes not only first enhanced fields Ea generated at ends of the microstructures 30 due to the LSPR but also a second enhanced field Eb generated above the microstructures 30 due to the SLR and the resonance state such as the QGM.

The enhanced electric field E enhances the Raman scattered light and generates the SERS. The enhanced electric field E is maximized by the second enhanced field Eb at a position S1 or a position S2 (the position S1 or the position S2 located at an opposite side of the plurality of microstructures 30 to the substrate 10 in the Z-axis direction and separated from the plurality of microstructures 30) separated upward from the plurality of microstructures 30. It can be said to be a feature of the phenomenon of the cooperative plasmon polariton that the enhanced electric field E is maximized at the position S1 or the position S2. The position S1 and the position S2 shown in FIG. 9 are located at the Z axis plus side of the plurality of microstructures 30.

According to such a configuration, the detection sensitivity of the electric field enhancement device 100 can be improved. For example, when the enhanced electric field E is generated only at the end of the microstructure 30 due to the LSPR, the effect that the enhanced electric field E is generated cannot be obtained unless the target substance is located in the vicinity of the microstructure 30. In general, since the probability that the target substance is located in the vicinity of the microstructure varies, the detection sensitivity is likely to decrease when the enhanced electric field is generated only at the end of the microstructure. In addition, the reproducibility of the detection also decreases. Further, when the size of the target substance is large, the target substance cannot enter an area between the microstructures adjacent to each other, and it may be difficult to locate the target substance near the microstructure in some cases.

In contrast, in the electric field enhancement device 100, the enhanced electric field E generated by the plurality of microstructures 30 is maximized at the position S1 or the position S2 (the position S1 or the position S2 separated from the plurality of microstructures 30 located at the opposite side of the plurality of microstructures 30 to the substrate 10 in the Z-axis direction) separated upward from the plurality of microstructures 30 in the normal direction. Therefore, the detection signal caused by the target substance can be enhanced without locating the target substance in the vicinity of the microstructure 30. As a result, the detection sensitivity can be improved. In addition, since it is not necessary to locate the target substance between the microstructures 30 adjacent to each other, samples in various sizes such as viruses and bacteria can be freely selected as the target substances.

Further, in the electric field enhancement device 100, since the position S1 or the position S2 of the local maximum point is separated from the vicinity of the microstructure 30, it is possible to provide the silicon oxide layer 40 that covers the microstructure 30. That is, even when the silicon oxide layer 40 is provided, it is possible to apply the enhanced electric field E to the target substance to enhance the detection signal caused by the target substance. Therefore, unintended chemical changes such as oxidation and sulfurization of the microstructure 30 can be suppressed. In particular, Ag is likely to be altered or deformed by oxidation, sulfurization, migration, or the like. In the electric field enhancement device 100, even when Ag is used as the microstructure 30, such alteration and deformation can be suppressed. As a result, the durability and reliability of the electric field enhancement device 100 can be improved.

Further, in the electric field enhancement device 100, unevenness due to the plurality of microstructures 30 can be alleviated by the silicon oxide layer 40. Therefore, flatness of the surface to be in contact with the target substance can be improved. Thus, the variation of the detection signal due to the target substance can be reduced in the in-plane direction.

Note that the second enhanced field Eb may be separated from the first enhanced field Ea as illustrated in FIG. 9, or may be continuous with the first enhanced field Ea.

Further, in FIG. 9, the local maximum point at which the enhanced electric field E is maximized is located at the position S1 or the position S2. Out of these, the position S1 shown in FIG. 9 is located in the silicon oxide layer 40. In this case, in a normal direction to the upper surface 42, a distance L1 from the microstructure 30 to the position S1 may be less than 100 nm, but is preferably no less than 100 nm, and more preferably no less than 200 nm. Accordingly, since the enhanced electric field E generated above the upper surface 42 can also be strengthened, even when the target substance is not located in the vicinity of the microstructure 30, in other words, even when the target substance is disposed on the upper surface 42, the enhanced electric field E acts on the target substance, and the detection signal caused by the target substance can be enhanced.

Further, in FIG. 9, the enhanced electric field E reaches the air layer across the upper surface 42. Further, the local maximum point of the enhanced electric field E may be located at the position S2 shown in FIG. 9. The position S2 shown in FIG. 9 is located in the air layer. That is, the enhanced electric field E may be maximized at a position separated from the silicon oxide layer 40 in the normal direction to the upper surface 42. In this case, the detection signal caused by the target substance disposed on the upper surface 42 can be further enhanced.

Further, in this case, a distance L2 from the upper surface 42 (a surface of the silicon oxide layer 40) to the position S2 (the local maximum point) may be no more than 100 nm, or may be more than 100 nm.

When the distance L2 is no more than 100 nm, the probability that the position S2 acts on the target substance disposed on the upper surface 42 is high as long as the size of the target substance is no more than 100 nm. Therefore, the detection signal caused by the target substance can particularly be enhanced.

When the distance L2 exceeds 100 nm, even when the size of the target substance exceeds 100 nm, the probability that the position S2 acts on the target substance disposed on the upper surface 42 is high. Therefore, even when target substances in various sizes are mixed, the detection signals caused by the target substances can be uniformly enhanced.

### 2. Method of Manufacturing Electric Field Enhancement device

Then, an example of a method of manufacturing the electric field enhancement device 100 will be described.

First, the dielectric layer 20 is formed on the substrate 10. The dielectric layer 20 is formed by, for example, a vapor deposition method, a sputtering method, a chemical vapor deposition (CVD) method, or an atomic layer deposition (ALD) method.

Then, the plurality of microstructures 30 is formed on the dielectric layer 20. The microstructures 30 are formed by forming a thin film using, for example, a vacuum deposition method or a sputtering method, and then patterning the thin film. Examples of the patterning method include photolithography and etching, a microcontact printing method, and a nanoimprint method.

Then, the silicon oxide layer 40 is formed on the dielectric layer 20 and the microstructures 30. Accordingly, the electric field enhancement device 100 can be obtained. The silicon oxide layer 40 is formed by, for example, a vapor deposition method, a sputtering method, a CVD method, an ALD method, or a sol-gel method.

### 3. Modified Examples of Electric Field Enhancement device

Then, electric field enhancement devices according to modified examples of the embodiment will be described.

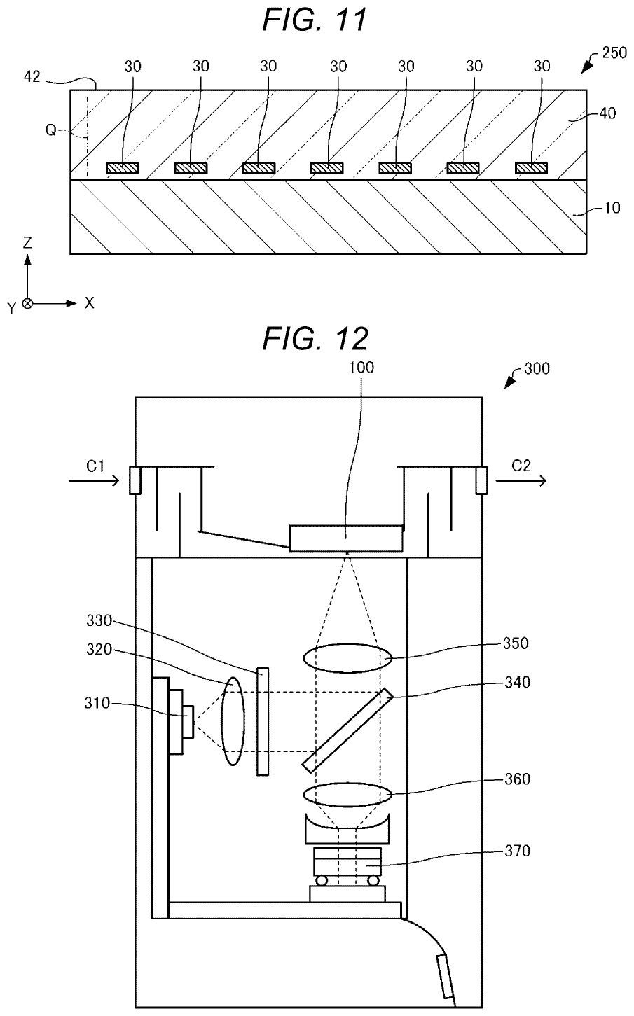

FIG. 10 is a cross-sectional view schematically illustrating an electric field enhancement device 200 according to a first modified example of the embodiment. FIG. 11 is a cross-sectional view schematically illustrating an electric field enhancement device 250 according to a second modified example of the embodiment.

The electric field enhancement device 200 according to the first modified example of the embodiment will hereinafter be described with a focus on differences from the electric field enhancement device 100 described above, and the description of substantially the same configuration will be omitted. Note that in FIGS. 10 and 11, substantially the same configurations as those of the electric field enhancement device 100 described above are denoted by the same reference symbols.

The electric field enhancement device 200 shown in FIG. 10 is substantially the same as the electric field enhancement device 100 except that a molecular trapping layer 50 is provided and that the shape of the microstructure 30 is different.

The molecular trapping layer 50 is disposed on the silicon oxide layer 40 so as to be in contact with the silicon oxide layer 40. The molecular trapping layer 50 is an organic molecular film, and is, for example, a self-assembled monolayer (SAM).

The thickness of the molecular trapping layer 50 is not particularly limited, but is preferably no less than 0.1 nm and no more than 1 nm, and more preferably no more than 0.4 nm.

The thickness of the molecular trapping layer 50 is measured from an observation image obtained by observing a cross-section of the molecular trapping layer 50 with an electron microscope. In the observation image, the length in the Z-axis direction of the molecular trapping layer 50 is measured at 10 or more points randomly extracted, and an average value thereof is defined as the “thickness”.

The molecular trapping layer 50 has a function of trapping the target substance. The molecular trapping layer 50 is appropriately selected depending on the type of the target substance, and examples thereof include an alkanethiol film and a silane coupling agent. The molecular trapping layer 50 is formed by, for example, a dipping method, a vacuum deposition method, a molecular vapor deposition (MVD) method, or a CVD method.

In the electric field enhancement device 200, since the molecular trapping layer 50 is disposed on the silicon oxide layer 40, deposition unevenness of the molecular trapping layer 50 can be alleviated. For example, when the silicon oxide layer is not provided and the molecular trapping layer is directly deposited on the microstructures and the substrate, the physical and chemical states are different between the surfaces of the microstructures and the surface of the substrate, and thus the deposition unevenness of the molecular trapping layer may occur in some cases.

In addition, in the electric field enhancement device 200, as described above, since the target substance is not required to be located in the vicinity of the microstructure 30, the selectivity of the molecular chain length in the molecular trapping layer 50 increases. Note that although not illustrated, a primer layer for improving adhesion between the silicon oxide layer 40 and the molecular trapping layer 50 may be disposed therebetween.

The electric field enhancement device 250 shown in FIG. 11 is substantially the same as the electric field enhancement device 100 except that the silicon oxide layer 40 is extended instead of the dielectric layer 20 shown in FIG. 1. That is, the silicon oxide layer 40 shown in FIG. 11 is also extended to the region where the dielectric layer 20 shown in FIG. 1 extends. Thus, there is provided a state in which the microstructures 30 are surrounded by the silicon oxide layer 40 in the cross-section shown in FIG. 11.

In such a modified example as described above, substantially the same advantages as those of the embodiment described above can be obtained.

### 4. Raman Spectroscopic Apparatus

Then, a Raman spectroscopic apparatus according to the embodiment will be described.

FIG. 12 is a diagram schematically showing a Raman spectroscopic apparatus 300 according to the embodiment.

### 4.1. Configuration

The Raman spectroscopic apparatus 300 shown in FIG. 12 includes the electric field enhancement device 100, a light source 310, a collimator lens 320, a polarization control element 330, a dichroic mirror 340, an objective lens 350, a condenser lens 360, and a detector 370. Note that for the sake of convenience of illustration, the electric field enhancement device 100 is simplified in FIG. 12.

The target substance is carried into the Raman spectroscopic apparatus 300 from a C1 direction and is then carried out in a C2 direction. For example, by driving a fan (not shown), the target substance is introduced from the carry-in port into a substance transport unit and is then discharged from a discharge port to the outside of the substance transport unit.

The light source 310 irradiates the electric field enhancement device 100 with the light. The light emitted from the light source 310 has a wavelength that induces resonance such as SLR and QGM in the electric field enhancement device 100. Examples of the light source 310 include a laser and a light emitting diode (LED). Examples of the laser include a vertical cavity surface emitting laser (VCSEL) and a photonic crystal surface emitting laser (PCSEL).

The light emitted from the light source 310 is, for example, collimated by the collimator lens 320, transmitted through the polarization control element 330, and guided toward the electric field enhancement device 100 by the dichroic mirror 340. The light traveling toward the electric field enhancement device 100 is condensed by the objective lens 350 and is incident on the electric field enhancement device 100. On this occasion, the target substance is in contact with the silicon oxide layer 40 of the electric field enhancement device 100.

When the light is incident on the electric field enhancement device 100, the enhanced electric field E is generated by the plurality of microstructures 30. When the target substance is located in the enhanced electric field E, the SERS light is generated therefrom. The SERS light is transmitted through the objective lens 350, then transmitted through the dichroic mirror 340 to be guided toward the detector 370. The SERS light traveling toward the detector 370 is condensed by the condenser lens 360 and then enters the detector 370.

The detector 370 detects the SERS light emitted from the electric field enhancement device 100. The detector 370 is, for example, a diffraction grating spectrometer. Then, in the Raman spectroscopic apparatus 300, the detector 370 performs spectral decomposition on the SERS light to obtain spectral information. Note that the detector 370 may be a Fabry-Perot etalon spectrometer.

### 4.2. Principle

FIG. 13 is a diagram illustrating the principle of the Raman scattering spectroscopy.

In FIG. 13, the target substance X is irradiated with the incident light Lin having a wavelength λin. Then, scattered light is emitted from the target substance X. The scattered light includes, besides the Rayleigh scattered light Ray having the same wavelength λ1 as the wavelength λin of the incident light Lin, the Raman scattered light Ram having a wavelength λ2 different from the wavelength λ1. An energy difference between the Raman scattered light Ram and the incident light Lin corresponds to the energy of an oscillation level, a rotation level, and an electron level of the target substance X. Since the target substance X has specific vibration energy according to the structure of the target substance X, the target substance X can be identified from the Raman scattered light Ram by using the incident light Lin having the wavelength λin.

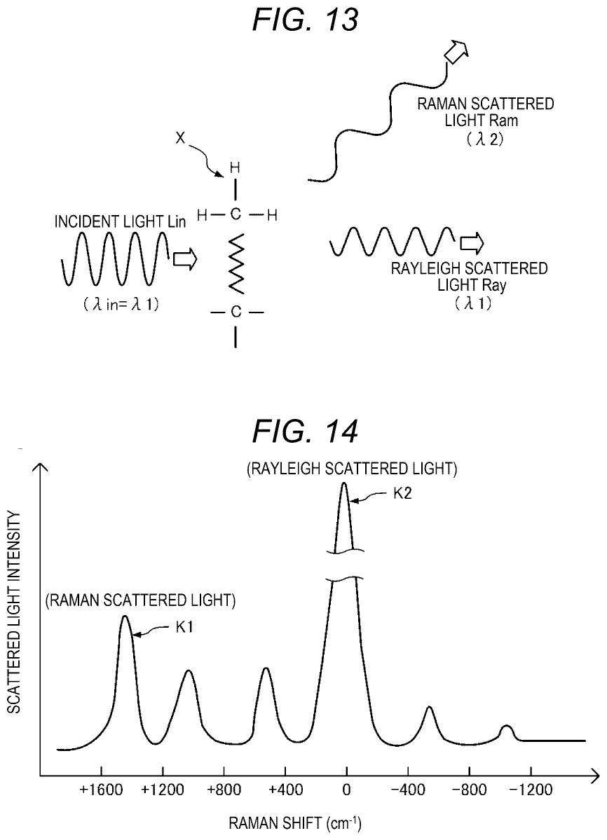

FIG. 14 is a schematic diagram illustrating an example of a Raman spectrum acquired by the Raman scattering spectroscopy. In FIG. 14, the horizontal axis represents a Raman shift. The Raman shift is a difference between the wave number (frequency) of the Raman scattered light Ram and the wave number of the incident light Lin, and has a value specific to the molecular bonding state of the target substance X.

When comparing the scattered light intensity K1 of the Raman scattered light Ram and the scattered light intensity K2 of the Rayleigh scattered light Ray illustrated in FIG. 14 with each other, it is understood that the scattered light intensity K1 of the Raman scattered light Ram is weaker. As described above, the Raman scattering spectroscopy is excellent in ability to identify the target substance X, but has a problem that the sensitivity to detect the target substance X is low. Therefore, in the Raman spectroscopic apparatus 300, the SERS is used to achieve high sensitivity.

### 5. Advantages Provided by Embodiment

The electric field enhancement device according to the embodiment includes the substrate 10, the plurality of microstructures 30, and the silicon oxide layer 40. The microstructures 30 are disposed on the substrate 10 and have electrical conductivity. The silicon oxide layer 40 covers the plurality of microstructures 30 and the substrate 10. Further, the enhanced electric field E generated by the plurality of microstructures 30 is maximized at a position at the opposite side of the plurality of microstructures 30 to the substrate 10 in the normal direction to the substrate 10 and separated from the plurality of microstructures 30.

According to such a configuration, the detection signal caused by the target substance can be enhanced without locating the target substance in the vicinity of the microstructures 30. As a result, the electric field enhancement device capable of improving the detection sensitivity can be obtained. In addition, since it is not necessary to locate the target substance between the microstructures 30 adjacent to each other, samples in various sizes such as viruses and bacteria can be freely selected as the target substances.

In the electric field enhancement device according to the embodiment, the enhanced electric field E may be maximized at the position S2 separated from the silicon oxide layer 40 in the normal direction to the substrate 10.

According to such a configuration, the detection signal caused by the target substance disposed at the opposite side of the plurality of microstructures 30 to the substrate 10 (on the upper surface 42) can further be enhanced.

In the electric field enhancement device according to the embodiment described above, when the position S2 at which the enhanced electric field E is maximized is defined as a local maximum point, a distance from the surface (the upper surface 42) of the silicon oxide layer 40 to the local maximum point (the position S2) may be no more than 100 nm.

According to such a configuration, the probability that the position S2 acts on the target substance disposed on the upper surface 42 increases. Therefore, the detection signal caused by the target substance can particularly be enhanced.

In the electric field enhancement device according to the embodiment described above, when the position S2 at which the enhanced electric field E is maximized is defined as a local maximum point, a distance from the surface (the upper surface 42) of the silicon oxide layer 40 to the local maximum point (the position S2) may exceed 100 nm.

According to such a configuration, even when target substances in various sizes are mixed, the detection signals caused by the target substances can be uniformly enhanced.

In the electric field enhancement device according to the embodiment described above, when the position S1 at which the enhanced electric field E is maximized is defined as a local maximum point, the local maximum point (the position S1) may be located inside the silicon oxide layer 40, and the distance from the microstructure 30 to the local maximum point (the position S1) in the normal direction to the substrate 10 may be no less than 100 nm.

According to such a configuration, since the enhanced electric field E generated above the upper surface 42 can also be strengthened, the enhanced electric field E acts on the target substance and the detection signal caused by the target substance can be enhanced without locating the target substance near the microstructure 30.

In the electric field enhancement device according to the embodiment described above, it is preferable for the microstructures 30 to be periodically arranged.

According to such a configuration, it is possible to reduce a variation in the intensity of the enhanced electric field E in the in-plane direction. In addition, since the microstructures 30 are periodically arranged, the SLR is easily induced.

In the electric field enhancement device according to the embodiment described above, the material of the microstructures 30 is preferably metal.

According to such a configuration, the enhanced electric field can further be strengthened.

In the electric field enhancement device according to the embodiment described above, the maximum height Rz as the surface roughness of the silicon oxide layer 40 is preferably no more than 20 nm.

According to such a configuration, the smoothness of the upper surface 42 can sufficiently be improved. Therefore, it becomes easy to achieve homogenization of the enhanced electric field formed above the upper surface 42. As a result, it becomes easy to improve the reproducibility of the detection. Further, even when target substances in various sizes are mixed, the detection signals caused by the target substances can be uniformly enhanced.

The Raman spectroscopic apparatus according to the embodiment described above includes the electric field enhancement device according to the embodiment described above, the light source 310, and the detector 370. The light source 310 irradiates the electric field enhancement device with the light. The detector 370 detects the light from the electric field enhancement device.

According to such a configuration, the Raman spectroscopic apparatus 300 capable of improving the detection sensitivity can be obtained.

Although the electric field enhancement device and the Raman spectroscopic apparatus according to the present disclosure have been described based on the preferred embodiment illustrated in the drawings, the present disclosure is not limited to the embodiment and the modified examples. For example, the configuration of each unit in the embodiment and the modified examples described above may be replaced with any configuration having substantially the same function, or may be added with any other configuration. Further, what is obtained by combining two or more of the embodiments and the modified examples described above may be adopted.

### Practical Examples

Then, specific examples of the present disclosure will be described.

### 6. Experimental Examples

### 6.1. Practical Example 1

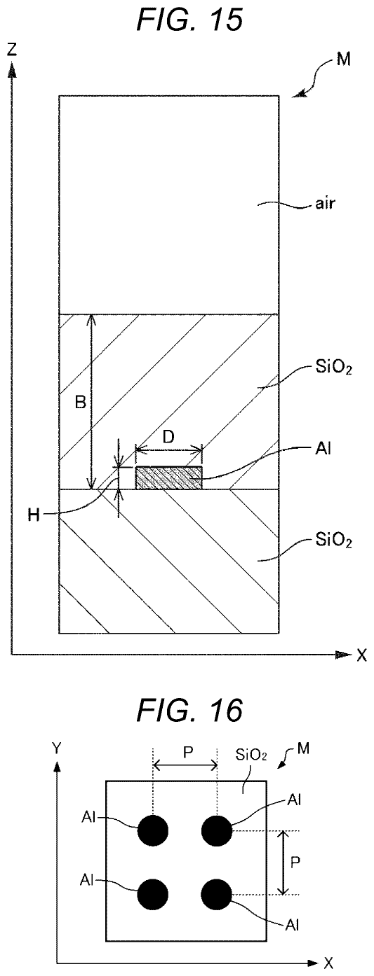

FIG. 15 is an X-Z cross-sectional view schematically illustrating a repeating unit of a model M used in a simulation. FIG. 16 is an X-Y cross-sectional view schematically illustrating the model M used in the simulation.

In the model M, as shown in FIG. 15, the material of the substrate was quartz glass (SiO₂), and the material of the silicon oxide layer was SiO₂.

In addition, the thickness B of the silicon oxide layer was 275 nm, the material of the microstructure was Al, the diameter D of the microstructure was 260 nm, and the thickness H of the microstructure was 140 nm. In addition, in the model M, as illustrated in FIG. 16, the array of the microstructures was in a square lattice shape, the shape of the microstructure was a cylinder, and the pitch P of the microstructures was 434 nm. Further, an air layer “air” was formed above the silicon oxide layer.

Then, light was incident from the substrate side of the model M shown in FIG. 15, and the intensity distribution of the enhanced electric field was calculated. The wavelength of the incident light was 434 nm.

### 6.2. Practical Example 2

In Practical Example 2, the intensity distribution of the enhanced electric field was calculated in substantially the same manner as in Practical Example 1 except that the thickness B of the silicon oxide layer was 349 nm, the diameter D of the microstructure was 277 nm, the thickness H of the microstructure was 139 nm, and the wavelength of the incident light was 450 nm in the model M described above.

### 6.3. Comparative Example 1

In Comparative Example 1, the intensity distribution of the enhanced electric field was calculated in substantially the same manner as in Practical Example 1 except that the thickness B of the silicon oxide layer was zero, that is, the silicon oxide layer was not provided, the material of the microstructures was Ag, the diameter D of the microstructure was 50 nm, the thickness H of the microstructure was 25 nm, the pitch P of the microstructures was 250 nm, and the wavelength of the incident light was 464 nm.

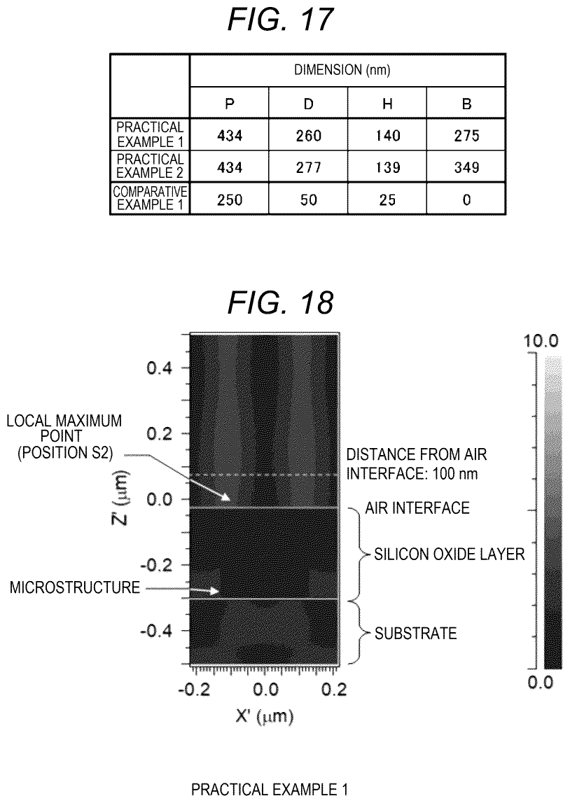

FIG. 17 is a table showing a comparison of principal parameters in Practical Examples 1 and 2 and Comparative Example 1.

### 7. Results in Experimental Examples

In each of the models of Practical Examples 1 and 2 and Comparative Example 1 described above, the simulation for estimating the distribution of the enhanced electric field was performed. A finite difference time domain (FDTD) method was used for the simulation. As simulation software, RSoft manufactured by Synopsys, Inc. was used.

FIGS. 18 to 20 show simulation results in Practical Examples 1 and 2 and Comparative Example 1, respectively. FIGS. 18 to 20 each show a normalized distribution of the enhanced electric field in the X-Z cross-section.

Shading in FIGS. 18 to 20 represents the intensity of the enhanced electric field in the X-Z cross-section. Specifically, when the X component of the enhanced electric field is represented by Ex and the Z component of the enhanced electric field is represented by Ez, a square root of (Ex²+Ez²), that is, √(Ex²+Ez²) is reflected in the shading in FIGS. 18 to 20.

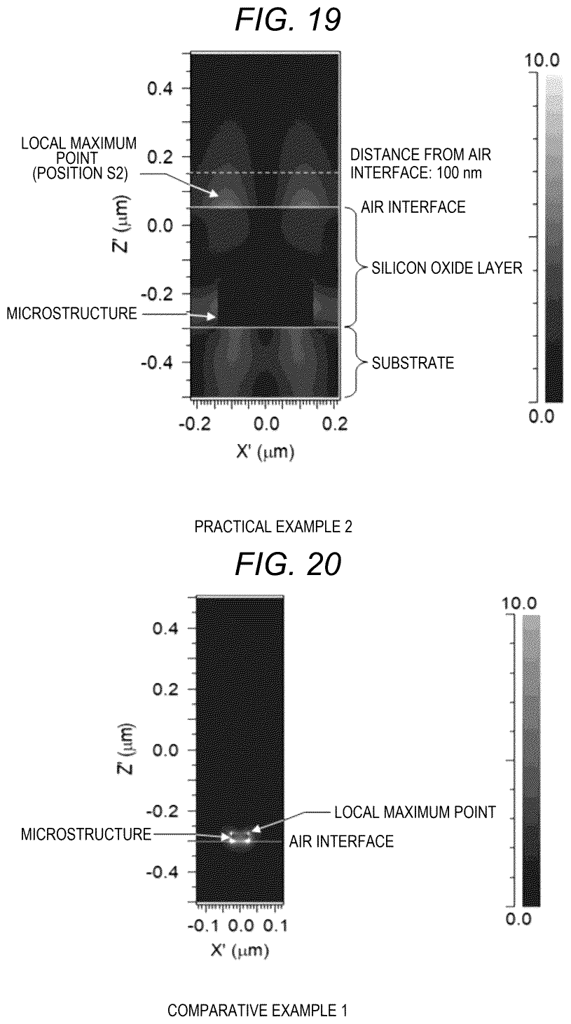

In FIGS. 18 and 19, the “AIR INTERFACE” represents an interface between the silicon oxide layer and the air layer. In FIG. 20, the “AIR INTERFACE” represents the interface between the substrate and the air layer.

In each of FIGS. 18 and 19, the enhanced electric field is maximized slightly above the air interface (at the air layer side). The distance from the air interface to the position S2 of the local maximum point shown in each of FIGS. 18 and 19 is no more than 100 nm. Further, the enhanced electric field shown in FIGS. 18 and 19 reaches a position at a distance no less than 100 nm from the air interface in the air layer.

On the other hand, in FIG. 20, no enhanced electric field was observed at a position away from the microstructure.

From the above result, it was confirmed that it was possible to realize the electric field enhancement device in which the enhanced electric field is maximized at the position S2 distant from the silicon oxide layer.

Further, as other experimental examples than the above, three models in which the refractive index of the substrate was changed in the model M were prepared, and the intensity distribution of the enhanced electric field was calculated in substantially the same manner as described above.

In the first model, the refractive index of the substrate was set to 1.267, which was 0.200 lower than the refractive index 1.467 of the silicon oxide layer.

In the second model, the refractive index of the substrate was made equal to the refractive index 1.467 of the silicon oxide layer.

In the third model, the refractive index of the substrate was set to 1.667, which was 0.200 higher than the refractive index 1.467 of the silicon oxide layer.

From the calculation results of the enhanced electric field, the values of the enhanced electric field at a position 1 nm above the air interface were compared. As a result, when the second model was used as a reference (100 %), the value of the enhanced electric field of the first model was 86 %, and the value of the enhanced electric field of the third model was 102 %. In the light of this result, it was found that the generation of the enhanced electric field was hardly affected as long as the difference between the refractive index of the substrate and the refractive index of the silicon oxide layer was no more than 0.200.

What is claimed is:

1. An electric field enhancement device comprising:
a substrate;
a plurality of microstructures provided to the substrate and having electrical conductivity; and
a silicon oxide layer configured to cover the plurality of microstructures and the substrate, wherein an enhanced electric field generated by the plurality of microstructures is maximized at a position located at an opposite side of the microstructures to the substrate and separated from the plurality of microstructures in a normal direction to the substrate.

2. The electric field enhancement device according to claim 1, wherein
the enhanced electric field is maximized at a position separated from the silicon oxide layer in the normal direction.

3. The electric field enhancement device according to claim 2, wherein
a distance from a surface of the silicon oxide layer to a position where the enhanced electric field is maximized is no more than 100 nm.

4. The electric field enhancement device according to claim 2, wherein
a distance from a surface of the silicon oxide layer to a position where the enhanced electric field is maximized exceeds 100 nm.

5. The electric field enhancement device according to claim 1, wherein
a position where the enhanced electric field is maximized is located inside the silicon oxide layer, and
a distance from the microstructures to the position where the enhanced electric field is maximized in the normal direction is no less than 100 nm.

6. The electric field enhancement device according to claim 1, wherein
the microstructures are periodically arranged.

7. The electric field enhancement device according to claim 1, wherein
a material of the microstructures is metal.

8. The electric field enhancement device according to claim 1, wherein
a maximum height as a surface roughness of the silicon oxide layer is no more than 20 nm.

9. A Raman spectroscopic apparatus comprising:
the electric field enhancement device according to claim 1;
a light source configured to irradiate the electric field enhancement device with light; and
a detector configured to detect light from the electric field enhancement device.

10. A Raman spectroscopic apparatus comprising:
the electric field enhancement device according to claim 2;
a light source configured to irradiate the electric field enhancement device with light; and
a detector configured to detect light from the electric field enhancement device.

11. A Raman spectroscopic apparatus comprising:
the electric field enhancement device according to claim 3;
a light source configured to irradiate the electric field enhancement device with light; and
a detector configured to detect light from the electric field enhancement device.

12. A Raman spectroscopic apparatus comprising:
the electric field enhancement device according to claim 4;
a light source configured to irradiate the electric field enhancement device with light; and
a detector configured to detect light from the electric field enhancement device.

13. A Raman spectroscopic apparatus comprising:
the electric field enhancement device according to claim 5;
a light source configured to irradiate the electric field enhancement device with light; and
a detector configured to detect light from the electric field enhancement device.

14. A Raman spectroscopic apparatus comprising:
the electric field enhancement device according to claim 6;
a light source configured to irradiate the electric field enhancement device with light; and
a detector configured to detect light from the electric field enhancement device.

15. A Raman spectroscopic apparatus comprising:
the electric field enhancement device according to claim 7;
a light source configured to irradiate the electric field enhancement device with light; and
a detector configured to detect light from the electric field enhancement device.

16. A Raman spectroscopic apparatus comprising:
the electric field enhancement device according to claim 8;
a light source configured to irradiate the electric field enhancement device with light; and
a detector configured to detect light from the electric field enhancement device.
